(19) United States
(12) Patent Application Publication
(10) Pub. No.: US 2025/0348067 A1
(43) Pub. Date: Nov. 13, 2025

(54) SINGLE HANDED CONTROLLER FOR REMOTE CONTROLLED AERIAL VEHICLES AND METHODS OF USE

(71) Applicant: University of Kansas, Lawrence, KS (US)

(72) Inventors: Reanne N. Reida, Lincoln, NE (US); Ronald M. Barrett, Lawrence, KS (US)

(73) Assignee: University of Kansas, Lawrence, KS (US)

(21) Appl. No.: 19/201,621

(22) Filed: May 7, 2025

Related U.S. Application Data
(60) Provisional application No. 63/643,740, filed on May 7, 2024.

(51) Int. Cl. G05D 1/223; G05D 1/222; G05D 109/20

(52) U.S. Cl. CPC G05D 1/223; G05D 1/2235; G05D 2109/20

(57) ABSTRACT

A single-handed controller for controlling an aerial vehicle includes a body having an elongated shape, a processor connected to the body, and a transmitter. The controller also includes a selectively positionable input mechanism and/or an orientation sensor that detects an orientation of the body. Based on instructions stored in a memory and executable by the processor, the controller is configured to detect a rotation of the body and/or detect a position of the input mechanism. The controller is also configured to send a command to change an angle of the aerial vehicle based on detecting the rotation of the body and/or send a command to change one or more of a thrust or a yaw of the aerial vehicle based on a position of the input mechanism.

### CROSS REFERENCE TO RELATED APPLICATIONS

This application claims priority to and the benefit of U.S. Provisional Patent Application No. 63/643,740, filed on May 7, 2024, which is hereby incorporated by reference in its entirety.

### BACKGROUND

Aerial vehicle toys, such as drones, are able to hover like helicopters using a plurality of propellers for lift and flight control with a body. Remote control devices and systems can be utilized to control aerial vehicles. Aerial vehicle toys have gained popularity for recreational and educational use, and offer users an engaging, interactive, and immersive experience.

### BRIEF SUMMARY

This summary briefly introduces concepts of the invention that are explained in depth in the detailed description. This summary is not intended to identify essential features or aid in limiting the scope of the invention.

In some embodiments, a single-handed controller for controlling an aerial vehicle includes a body having an elongated shape, an input mechanism positionable in a plurality of positions, an attitude sensor configured to detect a rotation of the body about at least one axis, and a transmitter configured to send commands to change an angle of the aerial vehicle based on detecting the rotation of the body about the at least one axis, and change one or more of a thrust or a yaw of the aerial vehicle based on the input mechanism being positioned in a first position of the plurality of positions.

In other embodiments, a method for single-handed remote controlling of an aerial vehicle includes detecting a rotation of a body of a controller in communication with the aerial vehicle, transmitting, from the controller and to the aerial vehicle, a command to change an angle of the aerial vehicle based on the rotation of the body, detecting a position of an input mechanism of the controller, and transmitting, from the controller and to the aerial vehicle, a command to change one or more of a thrust or a yaw of the aerial vehicle based on the position, wherein the rotation of the body and the position of the input mechanism are input to the controller by a single hand of a user of the controller.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

To further describe the embodiments as mentioned in the summary and those further outlined in the detailed description, illustrations are provided in the appended figures. Some elements are designated with reference numbers. Some of the same elements may show up in various figures and may use the same reference number or may differ, the context in the description will clearly define these references and elements. These drawings may depict some elements drawn to scale while others show concepts of embodiments. It is understood that the embodiments depicted in the figures are considered to be typical of the disclosure and therefore are to not be considered limiting of its scope. Additional details will be specified using the accompanying drawings in which:

FIG. 1 depicts top, side, and bottom views of an example embodiment of a controller for controlling an aerial vehicle, and FIG. 2 illustrates an example of an aerial vehicle having actuatable appendages for which the controller may be utilized to control, according to at least one embodiment of the present disclosure;

FIG. 3 illustrates various input commands for a controller and associated operations of an aerial vehicle, according to at least one embodiment of the present disclosure;

FIG. 4 illustrates various input commands for a controller and associated operations of an aerial vehicle, according to at least one embodiment of the present disclosure;

FIG. 5 illustrates various input commands for a controller and associated operations of an aerial vehicle, according to at least one embodiment of the present disclosure;

FIG. 6 illustrates various input commands for a controller and associated operations of an aerial vehicle, according to at least one embodiment of the present disclosure;

FIG. 7 illustrates various signals for communication among various devices as described herein, according to at least one embodiment of the present disclosure;

FIG. 8 illustrates various embodiments of accessories associated with a controller, according to at least one embodiment of the present disclosure;

FIG. 9 illustrates an embodiment of a multiplayer game utilizing a controller and aerial vehicle; and

FIG. 10 illustrates a method or a series of acts for single-handed remote controlling an aerial vehicle, according to at least one embodiment of the present disclosure.

### DETAILED DESCRIPTION

The specific embodiments described below are for the purpose of outlining examples of the presently disclosed invention. It should be understood that an actual implementation may include variations of described features and or other features not included in the below specifications and still fall within the scope of this disclosure.

Accordingly, terms such as ‘comprising,’ ‘including,’ ‘in which,’ and ‘having’ are intended to be inclusive and imply that elements other than the listed elements may exist. Terms ‘a,’ ‘an,’ and ‘the’ are intended to define the existence of one or more of these elements. It is not the intention of the embodiments referenced in this description to limit the disclosure and exclude the existence of additional embodiments that also incorporate the recited elements.

Immersing oneself into a fictional universe through virtual reality, augmented reality, cosplay, or role-play is a common form of entertainment. A market has been created in which collectible items, toys, games, or electronic devices are used to immerse oneself in these universes to make them more real. Of these devices, drones or other aerial vehicle toys have been created to play in fictional games such as Quidditch®, a game conceived by J. K. Rowling in the Harry Potter™ novels and movie series. The use of typical dual joystick controllers with such aerial vehicles may be seen as a barrier between the fictitious world and the real one.

The present disclosure provides a single handheld controller which may immerse the user into the universe of the game. For example, the single handheld controller may take the form of a wand, which may provide the experience of seemingly magical abilities of the controller. For instance, single handed use of the controller may facilitate maneuvering the aerial vehicle, including providing pitch, roll, yaw, and thrust inputs to the aerial vehicle. In this way, the user may seemingly control the aerial vehicle, as it were, through use of a wand and/or a spell-like command capability of the controller.

In at least one embodiment, the controller also controls actuation of appendages of the aerial vehicle, such as appendages that are not utilized for flight and/or maneuverability. As an example, the appendages may be in the form of one or more non-functional wings extending from the aerial vehicle. The appendages may actuate to reflect the maneuvering of the aerial vehicle and to simulate that the appendages are affecting the maneuvering of the aerial vehicle. For instance, the appendages may actuate based on associated thrust, pitch, roll, and/or yaw commands. In some cases, the appendages may actuate at different rates depending on an associated flight command. In this way, the aerial vehicle may imitate more realistic flapping, fluttering, vibrations, undulations, waving., other motions, of the appendages. For instance, the movements of the appendages may appear more realistic, and may give the impression that the appendages are achieving the maneuvering of the aerial vehicle.

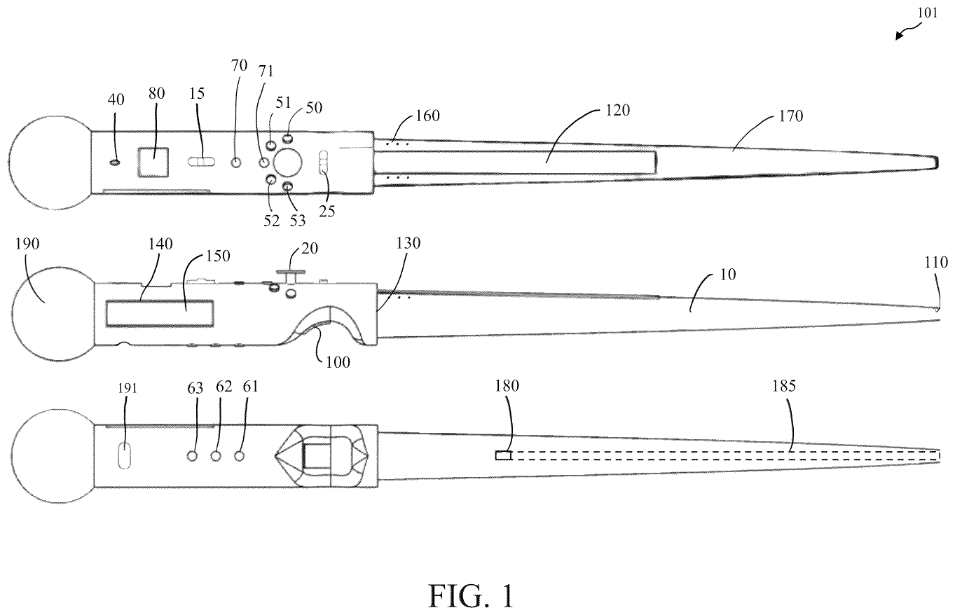

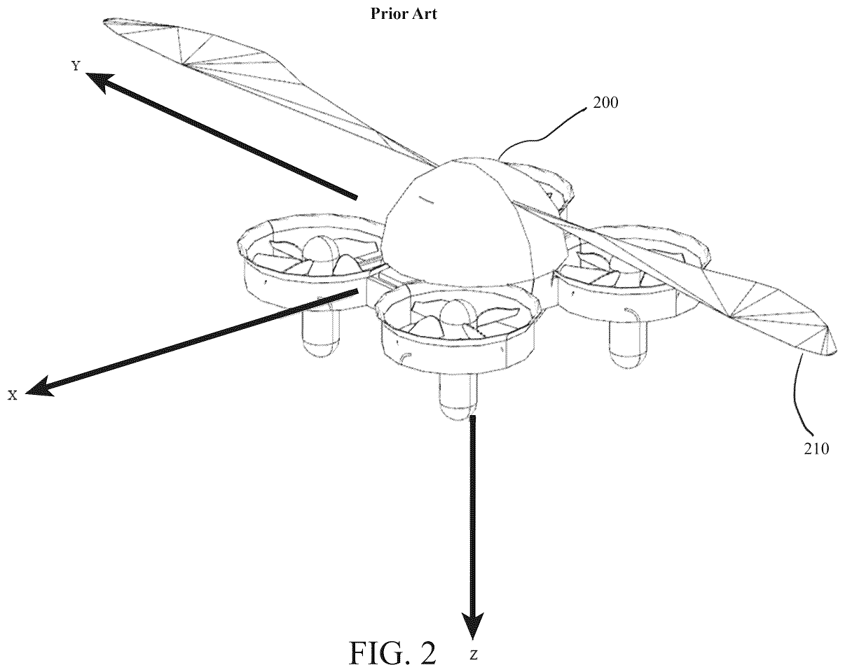

FIG. 1 depicts top, side, and bottom views of an example embodiment of a controller 101 for controlling an aerial vehicle, and FIG. 2 illustrates an example of an aerial vehicle 200 having actuatable appendages 210 for which the controller 101 may be utilized to control, according to at least one embodiment of the present disclosure. Embodiments of the aerial vehicle 200 and methods of use are described in detail in U.S. Pat. No. 10,561,956 filed on Jul. 27, 2015, by Ronald M. Barrett et al. and entitled “Moveable Member Bearing Aerial Vehicles and Methods of Use,” which is hereby incorporated by reference in its entirety.

In some cases, the controller 101 has a body 130 that is elongate such that a user can hold and use the controller with a single hand. For instance, the body 130 may have a length and/or a thickness that is proportional with a user's (e.g., adult and/or child) grip, grasp, or closed hand. The body 130 may include interfaces and/or ergonomic features such that the body 130 fits a user's hand. The ergonomics of the body 130 may be such that both right-handed and left-handed users can use the controller with little to no impediment.

In some embodiments, the controller 101 includes a joystick 20. The joystick 20 may be an input device through which a user can provide one or more control inputs to the controller 101. In some cases, the joystick controls thrust and/or yaw of a vehicle. For instance, the joystick 20 may control a speed at which one or more propellers or rotors rotate to maneuver an aerial vehicle. In some cases, tilting or angling the body 130 in one or more directions or orientations may control pitch and/or roll of the aerial vehicle as described herein.

In some embodiments, the controller 101 includes one or more buttons, dials, or other input means or peripherals. For example, the controller 101 may include one or more of buttons 50, 51, 52, and/or 53. The buttons 50-53 may facilitate controlling the trim of the aerial vehicle. Having the ability to trim such vehicle is useful because use or damage may cause the motors propelling an aircraft to unevenly deteriorate and not output the same force. This leads the aerial vehicle to drift in the direction(s) of the damaged/weakened motor(s). Each of the buttons 50-53 can be utilized to strengthen or weaken a corresponding motor output to trim the aerial vehicle and minimize drifting. For example, in some cases the aerial vehicle may include 4 motors, and each of the buttons 50-53 may control the trim of a given motor. In some cases, the controller 101 includes buttons 70 and/or 71. The buttons 70 and 71 may be reset buttons for the aerial vehicle and for the controller 101 respectively. For example, the aerial vehicle 200 may include one or more attitude sensors or orientation sensors which may detect pitch and/or roll, and the attitude sensors in the aerial vehicle and controller may be vulnerable to miscalibrations due to hard impacts and/or due to starting the device(s) in a non-level attitude. Similarly, the controller 101 may include one or more attitude sensors or orientation sensors for detecting tilting (in one or more axes) of the controller 101 for inputting commands via the controller 101 as described herein, which attitude sensors may become damages from impacts (or other events) to the controller 101. These issues may cause the aerial vehicle to become uncontrollable, for example, even when attempting to trim the aerial vehicle to mitigate drift. Accordingly, in some cases the buttons 70 and/or 71 may reset the attitude sensors for the aerial vehicle and/or the controller 101, including during use. In some cases, one or more buttons may command the aerial vehicle 200 to maintain one or more of a current heading, a position, an orientation, or combinations thereof.

In some embodiments, the controller 101 includes a switch 15. The switch 15 may be an on/off switch for the controller. A feature of this switch 15 may include the case such that if the controller 101 is turned off, a quick command issued just before controller shut down to the aerial vehicle paired for the aerial vehicle to also turn off, return, and/or land safely, as a safety feature to prevent an uncontrollable aircraft. In some cases, the controller waits for confirmation that the aerial vehicle 200 received the shutdown command and/or has shutdown, for example, before shutting down itself and/or disabling one or more features of the controller 101. In some cases, the controller 101 (e.g., via any of the receivers or antennas described herein) can receive a shutdown command from a remote device, such as a computing device or mobile device to which it is paired. This may be a feature of a parental control, for example.

The controller 101 includes a battery bay 140 in which batteries 150 can be loaded. The battery bay 140 may be located on the side of body 130 as to not interfere with elements on the top and bottom of the controller 101 in this embodiment. The battery bay 140 may be located at any other suitable location. The batteries 150 may be replaceable batteries or may be rechargeable batteries. The batteries 150 may be rechargeable via a charging port 191 and/or may be recharged via a wireless connection. The charging port 191 may be indicative or any power receiving unit for charging the batteries 150. In some cases, the controller 101 may connect (e.g., electrically) with a stand or charging base via the charging port 191 (e.g., wired or wirelessly) to charge the batteries 150.

A body extension 10 can be connected to the body 130, such as being screwed onto the body 130. The body extension 10 may be removably connected to the body 130 to facilitate serviceability of components and/or such that users can personalize the controller 101 with different versions or forms of the body extension 10. The body extension 10 may include and/or house one or more of a tip light 110, a light level indicator 120, speakers 160, an antenna 170, a boom microphone 180, and a boom microphone tube 185. Tip light 110 may be a light, such as an LED, blub or other light-emitting component. at the tip of the of the body extension 10. The tip light 110 may be used for special effects and/or visual displays associated with use of the controller 101. The tip light 110 may also indicate a state of charge of the battery 150. Light level indicator 120 may be a light, such as an array of one or more LEDs which may display one or more signals. The light level indicator 120 may be a two-axis light or array of lights for providing indication signals in two dimensions. For instance, the light level indicator 120 may display a light signal indicating the ‘levelness’ (e.g., in pitch and/or roll) of the aerial vehicle and/or the direction the aerial vehicle is moving. For instance, various LEDs of the array may be illuminated to indicate a direction and/or a levelness. In some cases, the light level indicator 120 may provide light signals which may indicate one or more of a current heading, a position, an orientation (or combinations thereof) of the aerial vehicle 200. In some cases, one or more of a light intensity, color, pattern, or position of light signals of the light level indicator 120 may indicate how quickly or slowly the aerial vehicle is moving (e.g., translating and/or rotating) in one or more directions. The light level indicator 120 may facilitate providing an immersive experience when operating the aerial vehicle and/or may aid the user in maneuvering the aerial vehicle should the user lose track of the orientation of the aircraft.

In some cases, a light 190 may be included, for example, at a base of the body 130. The light 190 may illuminate for providing one or more visual effects associated with use of the controller 101. In some cases, the light 190 may indicate user data, such as personality type (e.g., good, evil, passive, aggressive, etc.) and/or types of commands commonly performed by the user. For instance, the light 190 may indicate any of this information via a hue or color, a light intensity, and/or by showing one hue or color more than another. In some cases an intensity of the hue may indicate a level or capability of the user data.

In some cases, the light level indicator 120 and/or the light 190 may be utilized to indicated a battery charger or level, such as by one or more different colors and/or flashing patterns. In some cases, one or more indications may be provided by the controller 101 as audio, visual, and/or tactile indications. For instance, the controller 101 may indicate signals/commands received, signals/commands sent, player characteristics, game configurations, or other indications via any of these means. In some cases, the controller 101 includes a haptic, tactile, or vibrating component to provide haptic indications as described. In some cases, the controller provides feedback/indications in any of these forms to indicate when the aerial vehicle 200 and/or controller 101 are affected by another user's device as described herein, are proximate another user's device or solid object, or other indications and combinations thereof.

The speakers 160 may provide the user with sound effects associated with issuing commands or receiving commands from other users. These speakers 160 may also be used to communicate errors or other information to the user. The antenna 170 may include one or more antennas for communicating over radio frequency signals in any suitable spectrum or range. The antenna 170 can be used for various vehicle and controller communications. The boom microphone 180 may be representative of one or more components (e.g., sensors) which may communicate via acoustic signals, such as a microphone and/or emitter (speaker). The boom microphone 180 may generate and/or emit one or more acoustic signals, and the boom microphone tube 185 may facilitate directing the acoustic signals. For example, the boom microphone 180 and boom microphone 180 may be utilized to direct acoustic signals as a particular target, such as at an aerial vehicle and/or at another controller. The boom microphone 180 may receive one or more acoustic signals, and the boom microphone tube 185 may facilitate receiving acoustic signals from a limited or selected direction. In this way, the controller 101 can facilitate targeting a specific controller or aircraft for sending and/or receiving commands using acoustic signals. Using a boom microphone 180 to target aerial vehicles and/or controllers may be more accurate, directional, and/or selective than other spectra (e.g., RF signals) so that the user can more accurately ‘hit’ their targets with commands.

In some cases, the body 130 includes a housing 40. The housing 40 may be a portion of the body 130, or may be a separate component connected to the body 130. In some cases, the housing 40 is positioned at the base end of the body 130 as shown in FIG. 1. The housing 40 may contain or house an orientation device such as an attitude sensor. For instance, attitude sensors as described herein (e.g., for the controller and/or the aerial vehicle) may include any device or sensor which may determine an orientation, angle, or levelness in one or more axes. For instance, an orientation device may be an accelerometer, gyroscope, pendulum device, or other sensor(s) for determining orientation and/or rotational movement. The orientation device may be utilized for pitch and roll controls, such as by a user inputting pitch and/or roll controls by rotating the body 130 about one or more axes. The size of this housing 40 may be determined based on the room needed for such housing the orientation device. In some cases, the controller 101 does not includes an orientation device for pitch and roll controls.

In some embodiments, the controller 101 includes one or more of buttons 61, 62, and/or 63. The buttons 61-63 may be located on the bottom of the controller depicted in FIG. 1. The buttons 61-63 may be used to issue commands to aerial vehicles and other controllers. For example, various combinations of the buttons 61-63 may issue specific commands, which can be programmed into the controller by the user. In some cases, the controller 101 includes a microphone 90. The microphone may also be used to issue commands via voice or audio cues the user can program. For instance, in some cases, various commands can be issued by the buttons 61-63 and also by voice commands to the microphone 90. In some cases, voice commands may be programmed using words of the user's choice, including spells that may be found in the Harry Potter universe created by J. K. Rowling.

The controller 101 may include a trigger button 100 located on the bottom of the body 130. The trigger button 100 can be used to command the user's aerial vehicle to hold in place. For instance, in some cases the user may wish to utilize the controller 101 for performing one or more functions and/or controls that are not directed at or for an associated aerial vehicle, and the trigger button 100 may facilitate holding the aerial vehicle in place while the user otherwise directs or utilizes the controller 101 for another functionality (e.g., points the controller 101 at another aerial vehicle or controller, provides inputs/controls/commands via the controller 101 to another aerial vehicle or controller, etc.) In at least one case, this feature may be useful when the user is trying to issue commands to other vehicles and controllers by pointing the controller at the targeted object in order to accurately target a stronger command signal (e.g. acoustic signal), making the command more effective.

In some embodiments, the controller 101 includes a security device 80. For instance, the security device 80 may be a fingerprint scanner or may be another type of sensor, device, or technique for validating the user, such as a button combination password via any of the buttons or input mechanics described herein, an audio password, facial recognition via a camera or other suitable sensor, or other security feature and combinations thereof. The security device 80 may be used to lock/unlock the controller 101 so that unauthorized persons cannot use a user's controller. In some cases, the controller 101 may be directly unusable without deactivating the security device 80. In some cases, the security device 80 may be overridden by receiving signals from another device, such as from another controller, a paired computing device, etc. In some embodiments, the security device 80 may operate in conjunction with a stand or dock for the controller 101 which may lock or secure the controller 101 to the stand or dock, and only allow removal of the controller 101 once the security device 80 is deactivated or unlocked.

A variety of commands may be sent and/or received by the controller 101. Methods of detecting aircraft or controller signals and issuing commands may include the use of acoustic using boom microphone 180, infrared, radio-frequency (RF), infrared (IR), optical, or other spectra. The following paragraphs illustrate a variety of example commands which may be used (e.g., sent and/or received) in connection with the controller 101. It is understood that the commands or variations of the following commands that may be issued and received by the controller 101 are not limited to what is described herein. Furthermore, this includes the commands that users may program into the device. Any of the following commands, or other commands, may be performed based on providing an input via any of the buttons as described herein, as well as a voice input.

A ‘Turn on’ command can be used to turn on the user's aerial vehicle that is paired to their controller. Similarly, a ‘Turn off’ command can be used on both the user's aerial vehicle and controller along with other users' vehicles and controllers to immediately turn off the targeted item. The feature that controls other users' controllers and aerial vehicles may be included to mitigate or prevent property damage or injury as previously outlined. A ‘Turn on/off flapping’ command may be used to toggle the flapping appendages on the vehicle to turn on or off. A switch 25 as shown in FIG. 1 may be used as the toggle for this command.

The sensors in the aerial vehicles and controllers may require calibration upon start or after a hard impact. A user can use a ‘reset’ command for their controller or vehicle to recalibrate the sensors after such events. These commands can be input using buttons 70 and 71 or microphone 90 as depicted in FIG. 1. A ‘Trim’ command can be sent to trim the aircraft if it tends to drift when all controls are neutral. Buttons 50, 51, 52, and 53 in FIG. 1 can be used for aircraft trim.

‘Controller lights on/off’ commands can be used to turn the lights 110 and 190 in FIG. 1 on the user's controller and/or vehicle. ‘Change color’ commands can be used on the user's aerial vehicle and controller to cycle through colored light schemes of the level indicator 120 in FIG. 1 or other lighted elements.

‘Unlock/lock’ commands for the controller can be used to prevent unauthorized users from tampering with a user's aerial vehicle, controller, and player data. Voice commands using microphone 90 or scanning a fingerprint using fingerprint reader 80 as shown in FIG. 1 can be performed to unlock or lock the controller.

A ‘return’ command may be a command to the user's vehicle while in use to return to the user. An aircraft ‘hold’ command may be used via trigger button 100 to hold the user's aircraft in place for as long as the trigger is being compressed. A ‘Quick ascend’ a command can be sent to both the user's and other users' aerial vehicles where the targeted aerial vehicle of this command will rapidly ascend for a short period of time. Similar to the ‘quick ascend’ command, the ‘quick descend’ command may command the targeted aerial vehicle to rapidly descend for a period of time.

A ‘Slow’ command may be a command that can be sent to both the user's and other users' aerial vehicles and controllers. An aerial vehicle targeted by this command may move at a slower rate for a period of time whereas a targeted controller will lag and make controlling the vehicle feel sluggish to the user. A ‘Flip’ command can cause a targeted aerial vehicle to flip. A ‘spin’ command may cause a targeted aerial vehicle to spin for a period of time. A ‘fire’ command may sets a targeted aircraft or controller ‘on fire’ for a period of time in which the targeted item will behave erratically. If other aircraft or controllers are in the vicinity of the targeted item, the ‘fire’ can spread to those as well.

Using a ‘freeze’ command on an aerial vehicle may cause the vehicle to freeze in place for a period of time. If controller is targeted, the affected user will be unable to control their vehicle for a period of time and their vehicle will continue with the most recent command it was told before the freeze command froze its transmitter. For example, if a targeted user was inputting a roll command to their aerial vehicle at the time their controller was ‘frozen’ by another user, the targeted user's drone will continue to roll until the controller is unfrozen. This command may also be used to end or minimize the effect of a fire command.

A user can use a ‘track/follow’ command on their aerial vehicle to track or chase the nearest vehicle(s) for a period of time. A user may send a ‘pull’ command where aerial vehicles in the surrounding area to the user's vehicle will be pulled towards the user's vehicle. The user may still control their aircraft and ‘drag’ the affected vehicles around for a period of time. A ‘repel’ command, opposite to the ‘pull’ command, can be sent to an aerial vehicle such that surrounding vehicles will be ‘repelled’ and temporarily unable to travel towards the targeted vehicle.

A ‘mix control’ command can be sent to aerial vehicles and/or controllers such that affected targets will temporarily operate using inverted controls. A ‘disarm’ command can be sent to other controllers and render it unable to send any non-longitudinal, -lateral, or -directional control command for a period of time. A ‘shield/block’ command can be used on aircraft and controllers such that the targeted object is temporarily immune to receiving more commands or will be minorly affected by incoming commands. A ‘cancel command’ may be used to stop any ongoing command effects and block new ones from being sent in vicinity of the user who sent this command for a period of time.

An ‘Opponent vehicle control’ may be a command such that a user can temporarily take control of an opponent's vehicle. A ‘Swarm’ may be a command such that when an aerial vehicle is targeted, other vehicles in the area will be sent to surround the targeted vehicle for a period of time. Using a ‘stun’ command on an aerial vehicle or controller may temporarily render both aircraft and controller to be inoperative by quickly turning the affected targets off and on again. To know what a user's aerial vehicle or controller is being affected by, a ‘reveal’ command can be used such that the user's controller communicates the commands affecting it and the aircraft via speakers or a computing device. These commands are merely exemplary, and other commands may be implemented as well.

In some cases, the controller 101 may facilitate storing player data (e.g., locally or transiting to another device) that can be used to alter the effectiveness of commands sent and received by the controller described herein. In some cases, player data may affect a user's commands is through a user's time spent using the devices (e.g., controller 101 and/or aerial vehicle 200). As a user builds time on the device(s), their skill level can improve. For instance, and when certain parameters are met, such as a specific number of a specific command are used or number of hours used, the user can ‘level-up’ and unlock more commands and/or strengthen the ones they know. As a user becomes more skilled, their commands may include, but are not limited to, ‘freeze,’ ‘fire,’ or ‘shield.’ Additionally, increases in player skill can increase in strength and/or the amount of time the commands affect targeted vehicles and/or controllers. It is understood that command effectiveness is not limited to being dictated by a user's data, it may also include parameters such as the user's input timing, speech clarity, battery life, controller proximity, and/or other criterion

In some cases, a user's command effectiveness can be based on the amount of ‘good’ or ‘evil’ commands that are used. For instance, if a user uses more ‘good’ or more passive commands such as ‘shield’ to protect themselves and other users from ‘evil’ or aggressive commands, the strength of the user's ‘good’ commands are increased and more effective against ‘evil’ ones. Then if this user tries to use more aggressive commands, they may not be as effective. A similar idea applies to a more aggressive user where their ‘evil’ commands are stronger and ‘good’ commands are weaker.

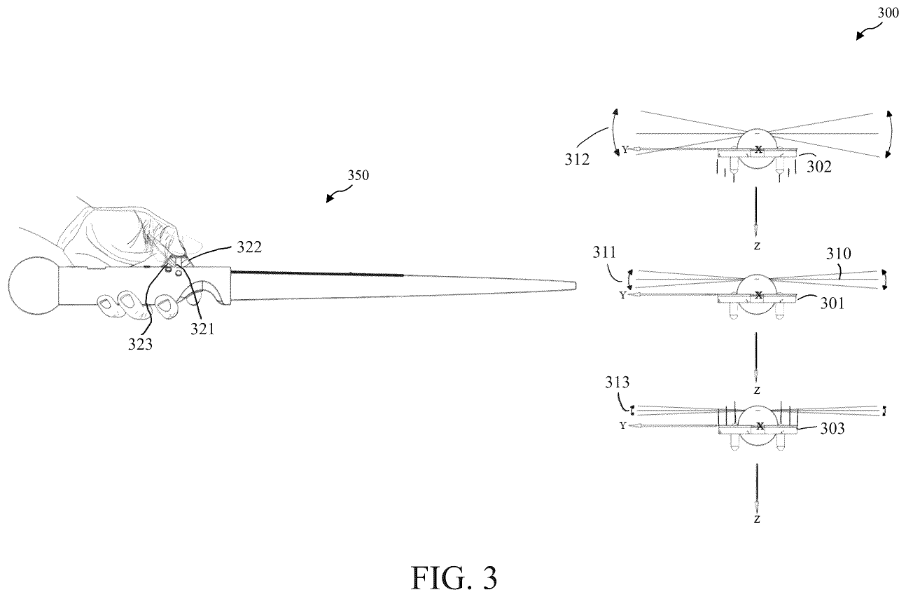

FIG. 3 illustrates various input commands for a controller 350 and associated operations of an aerial vehicle 300, according to at least one embodiment of the present disclosure. The controller 350 and the aerial vehicle 300 may be in accordance with any of the controllers and aerial vehicles described herein. The aerial vehicle 300 as shown in FIG. 3 is a front view of the aerial vehicle 300, such as a view in an x direction of the y-z plane. The controller 350 as shown in FIG. 3 is a side view of the controller 350.

The operation of FIG. 3 may be thrust operation. For example, by providing an input via a joystick as described herein, the controller 350 may provide a thrust command to the aerial vehicle 300. To elaborate, the joystick may be positionable in a neutral position 321, a first position 322, and a second position 323, such as by moving the joystick front to back. The first position 322 may be a forward movement of the joystick and the second position 323 may be a backward movement of the joystick. In some cases, these three positions are illustrative of numerous positions in which the joystick is positionable (e.g., for various magnitudes of the inputs/commands as described below). In some cases, the neutral position 321 may be associated with a neutral command of the controller 350, such as no thrust command being sent to the aerial vehicle 300. The first position 322 may be a positive position, and may control the aerial vehicle 300 to increase thrust. The second position 323 may be a negative position, and may control the aerial vehicle 300 to decrease thrust. In this way, the controller 350 may be actuated with a single hand to control the thrust of the aerial vehicle 300.

As mentioned, in some cases, the aerial vehicle 300 includes one or more appendages 310. The appendages 310 may be flapping or fluttering appendages such as wings which may flutter or flap to give the impression that the aerial vehicle 300 is flying by way of the flapping appendages 310. In some cases, the commands send via the controller 350 to control the aerial vehicle 300 may also control how the appendages 310 operate or flap. For instance, the thrust controls may change to what extent or magnitude the appendages 310 flap. As an illustrative example, a neutral position 301 may correspond with a neutral and/or initial position or operation of the aerial vehicle 300. In the neutral position 301, the appendages 310 may flutter or flap with a magnitude and/or speed 311, which may be a moderate and/or intermediate magnitude and/or speed. The neutral position 301 may correspond with the neutral position 321 of the controller 350. When the joystick is moved to the first position 322 (e.g., to increase thrust), the aerial vehicle 300 may accordingly change to a first position 302 wherein the appendages 310 flutter or flap with a magnitude and/or speed 312, which may be greater than the magnitude and/or speed 311 of the neutral position 301. When the joystick is moved to the second position 323 (e.g., to decrease thrust), the aerial vehicle 300 may accordingly change to a second position 303 wherein the appendages 310 flutter or flap with a magnitude and/or speed 313, which may be less than the magnitude and/or speed 312 of the first position. The magnitude and/or speed 313 may or may not be less than the magnitude and/or speed 311 of the neutral position, illustrating the fact that the change to the flapping of the appendages 310 (and the corresponding change in thrust) is decreased from a previous or initial state, rather than necessarily being less than that of the neutral position 301 (e.g., the neutral position 301 may be a starting or initial position rather than necessarily being a neutral or “middle” position). In this way, the flapping of the appendages 310 may provide the effect that the appendages 310 are causing the associated changes in thrust.

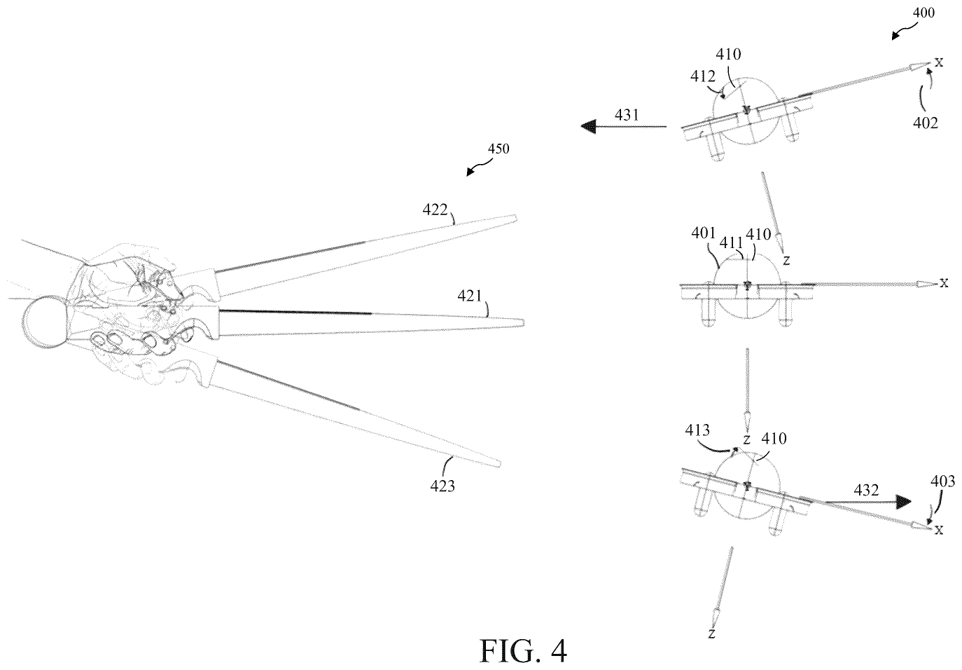

FIG. 4 illustrates various input commands for a controller 450 and associated operations of an aerial vehicle 400, according to at least one embodiment of the present disclosure. The controller 450 and the aerial vehicle 400 may be in accordance with any of the controllers and aerial vehicles described herein. The controller 450 and the aerial vehicle 400 as shown in FIG. 4 are side views, such as views in a y direction of the x-z plane.

The operation of FIG. 4 may be a pitch operation. For example, by providing input via the controller 450 about a horizontal axis, y axis, or axis perpendicular to a longitudinal axis of the controller 450, a corresponding pitch control may be provided to the aerial vehicle 400. To elaborate, The controller 450 may be positionable in a neutral position 421, a first position 422, and a second position 423. The neutral position 421 may correspond with the longitudinal axis of the controller 450 being positioned horizontally (or at some other reference or neutral angle). The first position 422 may be a positive position and may correspond with the longitudinal axis (e.g., the distal end of the controller 450) being inclined or angled up (e.g., positive) with respect to the neutral position 421 (e.g., the horizon). The second position may be a negative position and may correspond with the longitudinal axis (e.g., the distal end of the controller 450) being declined or angled down (e.g., negative) with respect to the neutral position 421 (e.g., the horizon). The first position 422 and second position 423 may be achieved by rotating the controller 450 in the x-z plane and/or rotating about an axis that is perpendicular to the longitudinal axis of the controller 450. These three positions may be illustrative of many positions in which the controller 450 may be rotated, for example, to achieve different magnitudes of the pitch inputs as described below.

In some cases, the neutral position 421 is associated with a neutral command of the controller 450, such as a command to utilize no pitch (e.g., horizontal pitch) of the aerial vehicle 400. For instance, as shown, a neutral position 401 of the aerial vehicle 400 may correspond with the aerial vehicle 400 remaining substantially horizontal and/or with no pitch relative to horizontal. The first position 422 may be associated with a command from the controller 450 to increase the pitch of the aerial vehicle 400. For instance, a first position 402 of the aerial vehicle 400 may correspond with the aerial vehicle 400 angling to a positive pitch relative to horizontal. The second position 423 may be associated with a command from the controller 450 to decrease the pitch of the aerial vehicle 400. For instance, a second position 403 of the aerial vehicle 400 may correspond with the aerial vehicle 400 angling to a negative pitch relative to horizontal. The positive pitch of the first position 402 may cause the aerial vehicle 400 to move in a first direction 431, such as in a backward direction. The negative pitch of the second position 403 may cause the aerial vehicle 400 to move in a second direction 432, such in a forward direction. In this way, the controller 450 may be actuated with a single hand to control the pitch of the aerial vehicle 400.

In some cases, the commands sent via the controller 450 to control the pitch of the aerial vehicle 400 may also control how appendages 410 operate or flap. For instance, the pitch controls may change to an angle or tilt of the appendages 410 flap. As an illustrative example, in the neutral position 401, the appendages 410 may be positioned at a neutral tilt 411, such as in a horizontal tilt. The neutral tilt 411 may correspond with the neutral position 421 of the controller 450. When the controller 450 is moved to the first position 422 (e.g., to increase pitch), the aerial vehicle 400 may accordingly change to the first position 402, and the appendages 310 may change to a first tilt 412. The first tilt 412 may be a positive tilt, for example, in the same direction as the positive pitch of the aerial vehicle 400. When the controller 450 is moved to the second position 423 (e.g., to decrease pitch), the aerial vehicle 400 may accordingly change to the second position 403, and the appendages 410 may change to a second tilt 413. The second tilt 413 may be a negative tilt, for example, in the same direction as the negative pitch of the aerial vehicle 400. In this way, the tilt of the appendages 410 may provide the effect that the appendages 410 are causing the associated changes in pitch.

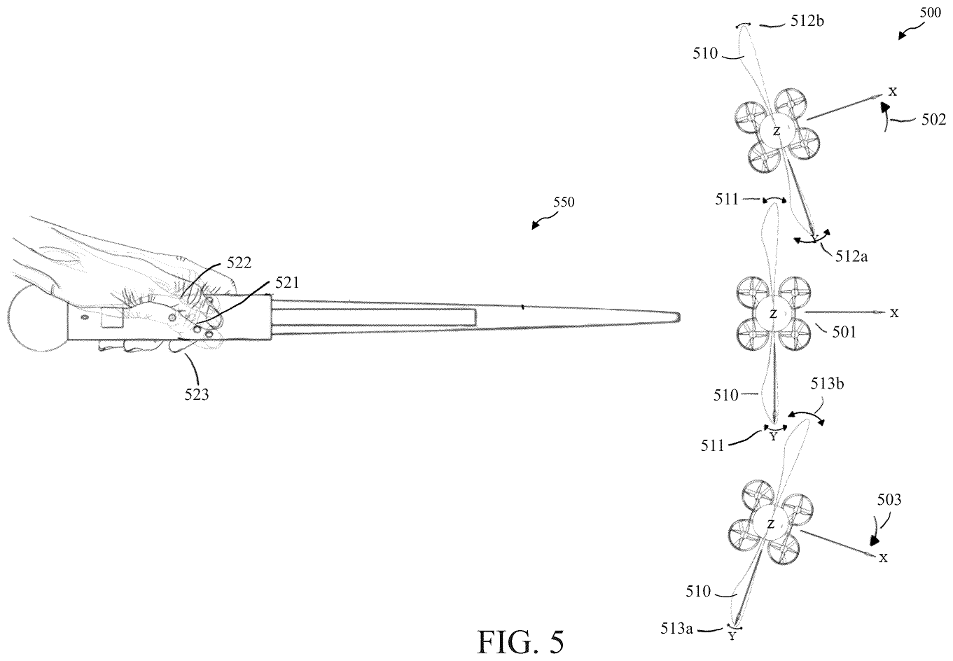

FIG. 5 illustrates various input commands for a controller 550 and associated operations of an aerial vehicle 500, according to at least one embodiment of the present disclosure. The controller 550 and the aerial vehicle 500 may be in accordance with any of the controllers and aerial vehicles described herein. The controller 450 and the aerial vehicle 400 as shown in FIG. 5 are top views, such as views in a z direction of the x-y plane.

The operation of FIG. 5 may be a yaw operation. For example, by providing input via a joystick as described herein, the controller 550 may provide a yaw command to the aerial vehicle 500. The joystick, while not illustrated in FIG. 5, may be located beneath the thumb of the user as illustrated in FIG. 5 and consistent with that shown and described in connection with FIG. 1. The joystick may be positionable in a neutral position 521, a first position 522, and a second position 523, such as by moving the joystick side to side. The first position 522 may be a left movement of the joystick and the second position 523 may be a right movement of the joystick. These three positions may be illustrative of many positions in which the controller 550 may be rotated, for example, to achieve different magnitudes of the pitch inputs as described below.

In some cases, the neutral position 521 is associated with a neutral command of the controller 550, such as a command to not change the yaw of the aerial vehicle 500. For instance, as shown, a neutral position 501 of the aerial vehicle 500 may correspond with the aerial vehicle 500 remaining substantially in the x direction. The first position 522 may be associated with a command from the controller 550 to increase the yaw of the aerial vehicle 500. For instance, a first position 502 of the aerial vehicle 500 may correspond with the aerial vehicle 500 angling the yaw in a positive (e.g., counterclockwise about the z axis) direction. The second position 523 may be associated with a command from the controller 550 to decrease the yaw of the aerial vehicle 500. For instance, a second position 503 of the aerial vehicle 500 may correspond with the aerial vehicle 500 angling the yaw in a negative (e.g., clockwise about the z axis) direction. The relative positioning of the first position 502 and second position 503 (e.g., the relative yaw) may not necessarily be the positions shown in FIG. 5, but rather, this exemplary figure may be illustrative of an increase or decrease to the yaw, respectively. In some cases, changing the yaw may change a heading of the aerial vehicle, such as by rotating an x axis of the aerial vehicle 500. For instance, changing the yaw in this way, in connection with a change in pitch angle as described herein, may affect the heading in which the aerial vehicle 500 moves. In this way, the controller 550 may be actuated with a single hand to control the pitch of the aerial vehicle 500.

In some cases, the commands send via the controller 550 to control the aerial vehicle 500 may control how appendages 510 operate or flap. For instance, the yaw controls may change to what extent or magnitude the appendages 510 flap. As an illustrative example, the neutral position 501 may correspond with a neutral and/or initial (e.g., straight) position or operation of the aerial vehicle 500. In the neutral position 501, the appendages 510 may flutter or flap with a magnitude and/or speed 511, which may be a moderate and/or intermediate magnitude and/or speed. The neutral position 501 may correspond with the neutral position 521 of the controller 550. The neutral position 501 may also correspond with the appendages 510 each operating at the same magnitude and/or speed. When the joystick is moved to the first position 522 (e.g., to increase yaw), the aerial vehicle 500 may accordingly change to the first position 502 wherein the appendages 510 flutter or flap with a different magnitude and/or speed. For instance, an inside appendage (e.g., in an opposite direction of the rotation of the yaw) may operate with a magnitude and/or speed 512a, which may be less than the magnitude and/or speed 511. Additionally, an outside appendage (e.g., in the direction of the rotation of the yaw) may operate with a magnitude and/or speed 512b, which may be a greater than the magnitude and/or speed 511. When the joystick is moved to the second position 523 (e.g., to decrease yaw), the aerial vehicle 500 may accordingly change to the second position 303 wherein the appendages 510 also flutter or flap with a different magnitude and/or speed. For instance, an outside appendage (e.g., in the direction of the rotation of the yaw) may operate with a magnitude and/or speed 513a, which may be less than the magnitude and/or speed 511. Additionally, an inside appendage (e.g., in the opposite direction of the rotation of the yaw) may operate with a magnitude and/or speed 513b, which may be a greater than the magnitude and/or speed 511.

The changes to the magnitude and/or speed of any of the appendages 510 should be understood as illustrating that an outside appendage increases in magnitude and/or speed from a previous condition while an inside appendage decreased in magnitude and/or speed from a previous condition, for example, rather than being limited to the specific relative values described in this illustrative example. It should also be noted that when an appendage is moving backwards during a yaw command, such as the appendage on the positive Y axis during the clockwise turn to position 503, this appendage will be flapping at a lower magnitude than the appendage moving forward, such as the appendage in the-Y direction during the turn to position 503. This is because the side of a vehicle on the inside of a turn is moving slower than the side on the outside, and therefore the appendages should reflect that. In this way, the flapping of the appendages 510 may provide the effect that the appendages 510 are causing the associated changes in yaw.

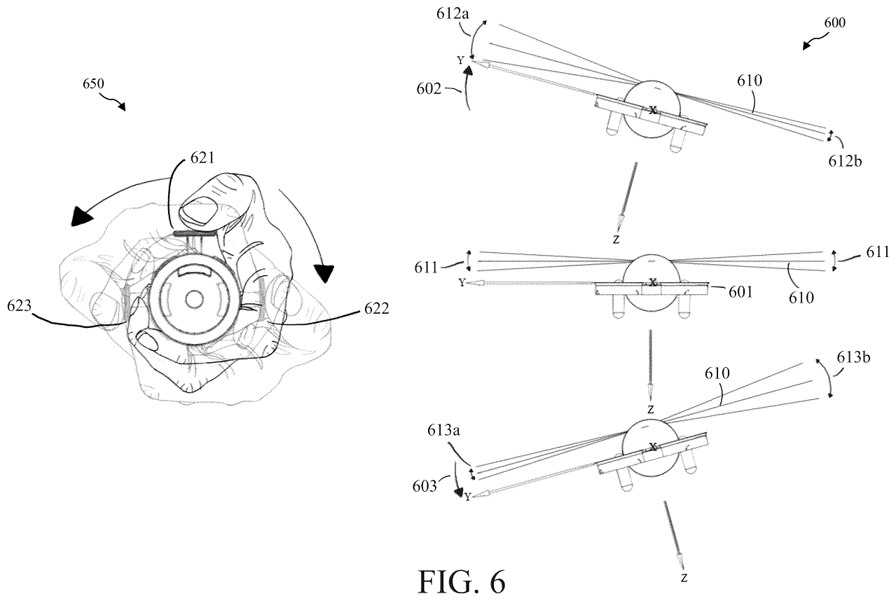

FIG. 6 illustrates various input commands for a controller 650 and associated operations of an aerial vehicle 600, according to at least one embodiment of the present disclosure. The controller 650 and the aerial vehicle 600 may be in accordance with any of the controllers and aerial vehicles described herein. The controller 650 and the aerial vehicle 600 as shown in FIG. 6 are front views, such as views in a y direction of the x-z plane.

The operation of FIG. 6 may be a roll operation. For example, by providing input via the controller 650 about a longitudinal axis of the controller 650 (e.g., x axis), a corresponding roll control may be provided to the aerial vehicle 600. To elaborate, The controller 650 may be positionable in a neutral position 621, a first position 622, and a second position 623. The neutral position 621 may correspond with the controller 650 being positioned at a neutral angle with respect to the longitudinal (x) axis, such as with the joystick and/or the user's thumb being vertically on top of the controller 650 or at a 12 o'clock position. The first position 622 may be a negative position and may correspond with the controller 650 being angled or rotated about the longitudinal (x) axis in a negative or clockwise direction (e.g., with respect the view and orientation shown). neutral angle). The second position may be a positive position and may correspond with the controller 650 being angled or rotated about the longitudinal (x) axis in a positive or counterclockwise direction. The first position 622 and second position 623 may be achieved by rotating the controller 650 in the x-z plane and/or rotating about the longitudinal axis (e.g., axis traversing a long dimension) of the controller 650. These three positions may be illustrative of many positions in which the controller 550 may be rotated, for example, to achieve different magnitudes of the roll inputs as described below.

In some cases, the commands send via the controller 650 to control the aerial vehicle 600 may control how appendages 610 operate or flap. For instance, the roll controls may change to what extent or magnitude the appendages 610 flap. As an illustrative example, the neutral position 601 may correspond with a neutral and/or initial (e.g., horizontal or level) position or operation of the aerial vehicle 600. In the neutral position 601, the appendages 610 may flutter or flap with a magnitude and/or speed 611, which may be a moderate and/or intermediate magnitude and/or speed. The neutral position 601 may correspond with the neutral position 621 of the controller 650. The neutral position 601 may also correspond with the appendages 610 each operating at the same magnitude and/or speed. When the controller 650 is rotated to the first position 622 (e.g., to decrease roll), the aerial vehicle 600 may accordingly change to the first position 602 wherein the appendages 610 flutter or flap with a different magnitude and/or speed. For instance, a left appendage (e.g., in the orientation and view shown) may operate with a magnitude and/or speed 612a, which may be greater than the magnitude and/or speed 611. Additionally, a right appendage (e.g., in the orientation and view shown) may operate with a magnitude and/or speed 612b, which may be a less than the magnitude and/or speed 611. When the controller 650 is rotated to the second position 623 (e.g., to increase roll), the aerial vehicle 600 may accordingly change to the second position 603 wherein the appendages 610 also flutter or flap with a different magnitude and/or speed. For instance, the left appendage may operate with a magnitude and/or speed 613a, which may be less than the magnitude and/or speed 611. Additionally, the right appendage may operate with a magnitude and/or speed 613b, which may be a greater than the magnitude and/or speed 611. The changes to the magnitude and/or speed of any of the appendages 610 should be understood as illustrating the corresponding changes in magnitude and/or speed from a previous condition, for example, rather than being limited to the specific relative values described in this illustrative example. In this way, the flapping of the appendages 610 may provide the effect that the appendages 610 are causing the associated changes in yaw.

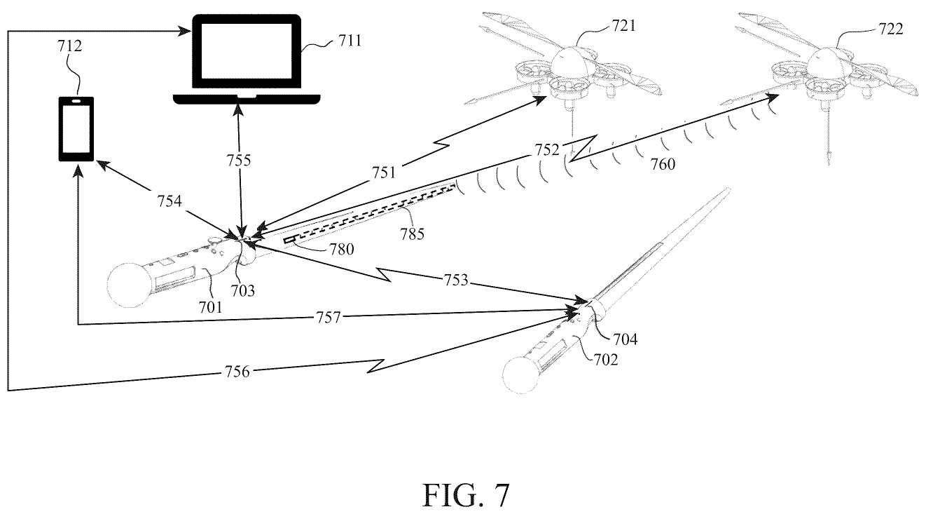

FIG. 7 illustrates various signals for communication among various devices as described herein, according to at least one embodiment of the present disclosure. For instance, illustrated are a controller 701, a controller 702, a computing device 711, a mobile device 712, as well as aerial vehicles 721 and 722.

In some cases, the controller 701 may communicate via various signals. For example, the controller 701 may communicate via one or more signals 751. The signal 751 may be a flight control or command signal to and from antenna 703 of controller 701 and a corresponding antenna of aerial vehicle 721. A signal 752 may be a signal for issuing commands to other users' aerial vehicles 722. In some cases, a signal 760 may be an acoustic signal communicated via a boom microphone 780 and boom microphone tubing 785 of the controller 701. For instance, the signal 760 may be utilized to target a specific aerial vehicle such that controller 701 will only send and/or receive the signal 760 with the aerial vehicle 722. For instance, the controller 701 may be directed or aimed at the aerial vehicle 722, and given that the boom microphone 780 may be highly directional, the controller 701 may detect only acoustic signals from the targeted aerial vehicle 722.

In some cases, a signal 753 is a signal for communicating with the controller 702, for inter-controller communication between antenna 703 of controller 701 and antenna 704 of controller 702. In some cases, signals 754 and 755 may facilitate communication with the computing device 711 and mobile device 712, respectively. These communications with controller 701 may facilitate managing player data, programing commands, configuring parental controls, and/or setting the game modes on the controller(s) 701 and/or 702. For instance, the controller 702 may similarly communicate with the computing device 711 and/or mobile device 712 via signals 756 and 757. The signals 756 and 757 may facilitate configuring the controller 702, managing game and player data, and facilitating multiple-player games with both the controller 701 and the controller 702. The computing device 711 and mobile device 712 (collectively devices 711/712) may represent connectivity capabilities of the controller(s) with any computing device, such as computers, tablets, smartphones, etc. For instance, a controller may not necessarily be connected to two distinct devices, but rather FIG. 7 is illustrative of the connectivity of the controllers with any of a variety of types of devices. In some cases, the devices 711/712 may provide virtual reality (VR) and/or augmented reality (AR) experiences, such as by an associated display device. For instance, VR and/or AR may change what the user sees in their surroundings such as to, for example, show the effects of commands sent or received, identify other users and their devices, and/or visually change the environment the user is playing in.

In some embodiments, the controller 101 may include a processor and memory for implementing any of the features that are described herein as being performed by the devices 711/712, such as storing player data, implementing mode configurations, etc. In some cases, the controller 101 may be updated via the processor. The processor may be positioned, included, and/or associated with the charging port 191.

In some embodiments, various game modes may be configured using devices 711/712. Such game modes may include but are not limited to, single player games such as quests or training, and multiplayer games such as duels, quests, battle royale style games, team games, or other games of the users' imagination. Example game modes are described in the following paragraphs. In some cases, physical and/or digital items may be collected which may facilitate strengthening skills and abilities of the user. For instance, the collectible items may include physical and/or digital amulets, coins, jewelry, cloaks, or other items. In some cases, collectible items may be purchased, for example, via a store in an associated application, or items may be found or earned by the training modes. Collectible items may not necessarily be associated exclusively with the training mode, but rather, may be obtained and utilized in other modes as well. In some cases, collectible items may store player data, for example, to take on a personality, characteristic, skill, ability, playing style, etc., of the player. In some cases the collectible items may have their own personality, characteristics, and/or abilities, which may be augmented (e.g., improved or reduced) based on a characteristic, personality, skill, ability, playing style, etc., of the user.

In training mode and using devices 701/702 with a computer/mobile application or website, training modules may instruct a user on how to use the controller. When each training module is complete, the user can ‘level-up’ and new commands may be enabled or unlocked on the controller and/or known commands will become stronger. These training modules may also outline how to properly use the controller and aerial vehicle for the safety of people and property.

Questing can be done individually or with other users. In questing mode, certain tasks may be given to the users that the users must complete to build their skill level and level-up. These tasks may include puzzles or riddles the user(s) must solve that help them learn how to send a new command or improve their techniques. These commands may not be outlined in the training mode modules depending on the skill level. Users may choose the quests based on the skills they want learn.

In battling mode, two or more users may face off in a free-for-all or team manner, and can ‘fight’ to be the last aircraft flying. This game mode can involve ‘vehicle and controller health.’ For example, after receiving damage from ‘hits’ with bad spells, the aerial vehicle and/or controller may become inoperative. In some cases, healing functionalities may be implemented.

In some cases, at least one controller must be connected and/or coupled to a device and/or application in order to enable various modes. For instance, this may facilitate setting up boundaries, establishing rules, selecting a number of rounds, selecting a time per round, and managing player data. The users may specify the dimensions and shape of the battle arena, rules of what commands are allowed/not allowed, number of rounds, time per round, and create/manage teams and ‘friendly fire’ options. Handicaps may also be added for certain players depending on the difference in skill level.

In some cases, users playing can input their usernames to the shared computing device to link their account to the game or use a guest profile if they don't wish to share their data. Utilizing use names can track the health or other metrics of their controller and or vehicle for the game if the users wish to track it. Users can track the status of their vehicle and controller on their personal computing devices as well, even if they don't put in the game parameters.

In some cases, users can define other rules for creativity in game modes. For instance, rules may be created to outline a story or role-play scenario or may be used to replicate other games as found in real life or fiction. In some cases, commands sent to a controller and/or aerial vehicle may be stronger based on multiple controllers sending the same or similar command to the same targeted device.

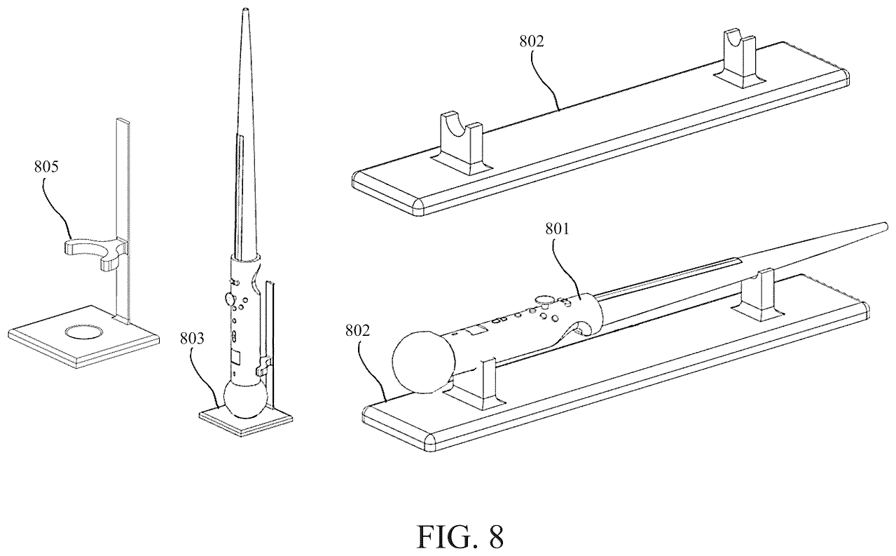

FIG. 8 illustrates various embodiments of accessories associated with a controller 801 as described herein, according to at least one embodiment of the present disclosure. For instance, in some cases, the controller 801 may be mateable and/or connectable to a horizontal stand 802. In other cases, the controller 801 may be mateable and/or connectable to a horizontal stand 803 and/or a horizontal stand 805. In some cases, any of these stands may be charging stands which may connect to the controller 801 for charging the controller 801. In some cases, any of the stands may implement wireless charging techniques to charge the controller 801.

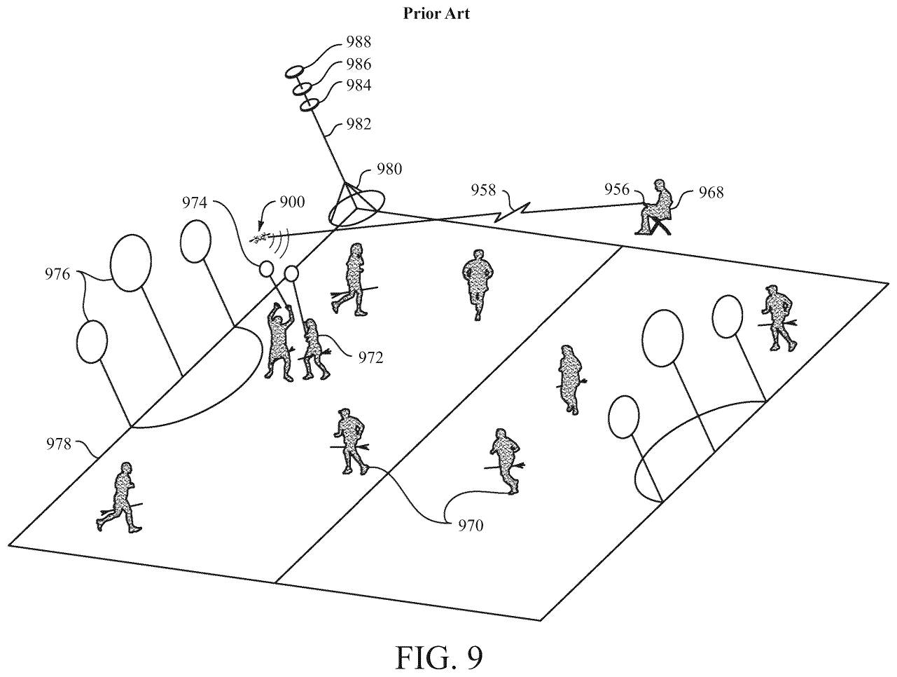

FIG. 9 illustrates an embodiment of a multiplayer game utilizing a controller and aerial vehicle as described herein. Further details regarding the multiplayer game of FIG. 9 is described in U.S. Pat. No. 10,561,956, previously referenced and incorporated herein.

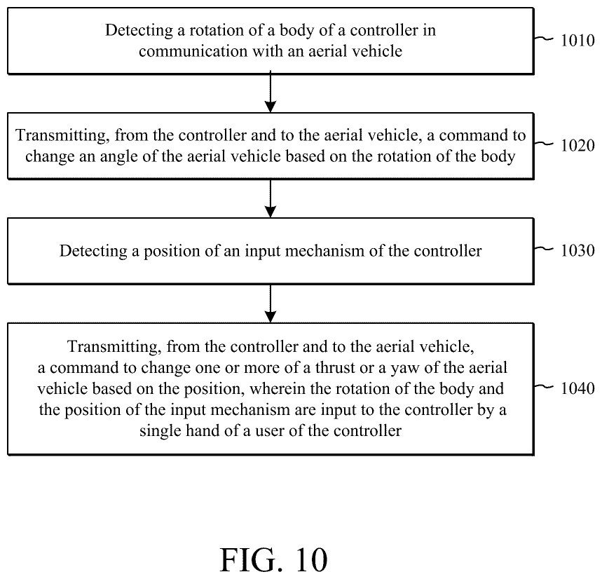

FIG. 10 illustrates a flow diagram for a method 1000 or a series of acts for single-handed remote controlling an aerial vehicle as described herein, according to at least one embodiment of the present disclosure. While FIG. 10 illustrates acts according to one embodiments, alternative embodiments may add to, omit, reorder, or modify any of the acts of FIG. 10.

In some embodiments, the method 1000 includes an act 1010 of detecting a rotation of a body of a controller in communication with the aerial vehicle.

In some embodiments, the method 1000 includes an act 1020 of transmitting, from the controller and to the aerial vehicle, a command to change an angle of the aerial vehicle based on the rotation of the body.

In some embodiments, the method 1000 includes an act 1030 of detecting a position of an input mechanism of the controller.

In some embodiments, the method 1000 includes an act 1040 of transmitting, from the controller and to the aerial vehicle, a command to change one or more of a thrust or a yaw of the aerial vehicle based on the position, wherein the rotation of the body and the position of the input mechanism are input to the controller by a single hand of a user of the controller.

In some embodiments, the detecting the rotation includes detecting a first rotation of the body about a first axis, and detecting a second rotation of the body about a second axis. in some embodiments, transmitting the command to change the angle includes transmitting a pitch command to change a pitch of the aerial vehicle based on the first rotation, and transmitting a roll command to change a roll of the aerial vehicle based on the second rotation.

In some embodiments, the aerial vehicle includes at least one actuatable appendage that is actuatable to flutter, and the method further includes, in connection with transmitting the pitch command, transmitting a command to adjust an angle of the at least one actuatable appendage, and in connection with transmitting the roll command, transmitting a command to adjust one or more of a magnitude or a speed of fluttering of the at least one actuatable appendage.

In some embodiments, detecting the position includes detecting a first axial component of the position along a first axis, and detecting a second axial component of the position along a second axis. In some embodiments, transmitting the command to change one or more of the thrust or yaw includes transmitting a thrust command to change the thrust of the aerial vehicle based on the first axial component of the position, and transmitting a yaw command to change the yaw of the aerial vehicle based on the second axial component of the position.

In some embodiments, the aerial vehicle includes actuatable appendages that are actuatable to flutter including a first actuatable appendage and a second actuatable appendage. In some embodiments, the method further includes, in connection with transmitting the thrust command, transmitting a first command to adjust one or more of a magnitude or a speed of fluttering of the actuatable appendages, and in connection with transmitting the yaw command, transmitting a second command to adjust the one or more of the magnitude or the speed of the fluttering of the actuatable appendages, wherein the one or more of the magnitude or the speed of the fluttering of the actuatable appendages is based on a combination of both the first command and the second command, and wherein the second command causes the first actuatable appendage and the second actuatable appendage to flutter at one or more of a different magnitude or a different speed.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry, software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

### INDUSTRIAL APPLICABILITY

The following description from ¶¶ [0092]-[0216] includes various embodiments that, where feasible, may be combined in any permutation. For example, the embodiment of ¶ [0092] may be combined with any or all embodiments of the following paragraphs. Embodiments that describe acts of a method may be combined with embodiments that describe, for example, systems and/or devices. Any permutation of the following paragraphs is considered to be hereby disclosed for the purposes of providing “unambiguously derivable support” for any claim amendment based on the following paragraphs. Furthermore, the following paragraphs provide support such that any combination of the following paragraphs would not create an “intermediate generalization.”

In some embodiments, a single-handed remote-controlled aircraft controller includes a body having an elongated shape; at least one attitude sensor and/or input mechanism; and at least one transmitter configured to send pitch and/or roll commands to the remote-controlled aircraft based on detected attitude of the body and/or to send thrust and/or yaw commands based on a position of the input mechanism.

In some embodiments, the controller further includes at least one button and/or dial to trim the aircraft.

In some embodiments, the at least one button and/or the at least one dial is configured to adjust trim of the aircraft.

In some embodiments, the at least one button is configured to adjust and/or reset the attitude sensors in the controller and/or to send signals to reset the attitude sensors in the aircraft.

In some embodiments, the at least one button is configured to send commands to the aircraft to maintain one or more of a current heading, a position, an orientation, or combinations thereof of the aircraft.

In some embodiments, the controller further includes an indicator configured to indicate one or more of a current heading, a position, an orientation, or combinations thereof of the aircraft.

In some embodiments, the indicator includes a two-axis light and/or vibration indicator.

In some embodiments, the two-axis light and/or vibration indicator is configured to indicate the orientation of the aircraft relative to ground.

In some embodiments, the two-axis light and/or vibration indicator is configured to indicate levelness of the aircraft in pitch and/or roll.

In some embodiments, one or more of light intensity, colors, position of the light on the controller, vibrations, or combinations thereof indicate how quickly or slowly the aircraft is moving in one or more directions.

In some embodiments, the indicator is used to indicate user data and/or personality of types of commands commonly performed by the user.

In some embodiments, showing more of one hue than another hue indicates that the user uses more passive commands than aggressive command.

In some embodiments, an intensity of the hue indicates a leveling up of the user's commands.

In some embodiments, the controller further includes a battery indicator configured to indicate remaining battery charge using one or more of different colors and/or flashing patterns.

In some embodiments, the controller further includes a power receiving unit.

In some embodiments, the power receiving unit includes a charging base and/or port such that a battery of the controller can be charged via a cable.

In some embodiments, the power receiving unit is configured to receive a wireless charge.

In some embodiments, the controller further includes at least one removable battery.

In some embodiments, the controller further includes at least one sensor and/or receiver.

In some embodiments, the at least one sensor and/or receiver is configured to receive immediate shut down commands from a main controller.

In some embodiments, after receiving an immediate shutdown command, the controller sends a command to the aircraft to shut down.

In some embodiments, after the controller sends a command to the aircraft to shut down, the controller waits for confirmation that the shutdown command was received.

In some embodiments, after receiving confirmation that the shutdown command was received, one or more features of the controller is disabled.

In some embodiments, after receiving confirmation that the shutdown command was received, all features of the controller are disabled.

In some embodiments, the body is thin enough that a person can hold and/or operate the body with one hand.

In some embodiments, the at least one attitude sensor is configured to detect roll and/or pitch commands issued by a pilot via controller roll and/or tilt.

In some embodiments, the at least one attitude sensor is configured to detect tilting of the body.

In some embodiments, when tilting of the body is detected, the transmitter sends a command to the aircraft to flutter appendages of the aircraft.

In some embodiments, the directional controller is configured to communicate one or more of yaw instructions, thrust instructions, appendage fluttering instructions, or combinations thereof.

In some embodiments, the input mechanism includes at least one directional controller.

In some embodiments, at least one directional controller includes a joystick.

In some embodiments, at least one toggle switch or button is used to turn on and off a flapping effect of the aircraft.

In some embodiments, one or more flutter controls correspond to attitude and/or thrust commands given.

In some embodiments, a flapping frequency of the aircraft changes with thrust level.

In some embodiments, each appendage flaps at a different rate than other appendages for roll and/or yaw commands

In some embodiments, appendages tilt for pitch commands.

In some embodiments, the controller further includes at least one input to send an instruction to one or more of the aircraft, one or more of other controllers, or combinations thereof.

In some embodiments, the instruction is sent after detecting one or more input patterns.

In some embodiments, the at least one input includes one or more of a button, a microphone, a sensor, or combinations thereof.

In some embodiments, the one or more input patterns include one or more button combinations, one or more voice commands, one or more motion patterns, or combinations thereof.

In some embodiments, the controller further includes at least one sensor and/or transmitter to sense other users' aircraft and/or other users' controllers via one or more of RF, one or more of IR, one or more of acoustic, one or more of optical, one or more of other spectra, or combinations thereof.

In some embodiments, when the controller is pointed at the other users' aircraft or the other users' controller and when the user sends a command from the controller, the transmitter sends command signals to a targeted aerial vehicle and/or a targeted controller.

In some embodiments, the controller further includes a processor and memory with instructions stored thereon that are executable by the processor.

In some embodiments, the memory stores one or more parental controls, one or more user preferences, one or more game mode data, or combinations thereof.

In some embodiments, one or more features and/or one or more capabilities of the controller can be altered and/or toggled on or off based on one or more of the one or more parental controls, the one or more user preferences, the one or more game mode data, or combinations thereof.

In some embodiments, the memory stores one or more of aircraft data, one or more of controller data, one or more of user data, or combinations thereof.

In some embodiments, the instructions include determining a user's ability level and/or command level.

In some embodiments, the user's ability level and/or command level affects one or more of abilities of the commands sent by the controller.

In some embodiments, the user's ability level and/or command level affects an ability of the user to pair voice commands to one or more button combinations that are used to send commands.

In some embodiments, the controller further includes a security system.

In some embodiments, the security system includes one or more of a fingerprint reader, button combination password, an audio password, other security feature, or combinations thereof.

In some embodiments, without deactivating the security system, the controller is directly unusable.

In some embodiments, the security system is configured to be temporarily overridden by other users' controllers via one or more sensors and/or one or more receivers of the controller.

In some embodiments, one or more game modes including Training mode, Questing mode, Battle mode, other game modes, or combinations thereof can be selected for the controller.

In some embodiments, the one or more game modes are selected for the controller by a computing device.

In some embodiments, the memory includes an application including instructions executable by the processor to receive communication from one or more controllers paired with one or more aerial vehicles.

In some embodiments, player data, user preferences, program commands, parental control settings, game mode selection, game mode rule management, team configuration, other game data, or combinations thereof are sent from the controller.

In some embodiments, player data, user preferences, program commands, parental control settings, game mode selection, game mode rule management, team configuration, other game data, or combinations thereof received by the controller.

In some embodiments, play area boundaries, number of rounds, time per round, player handicaps, other game data, or combinations thereof are sent from the controller.

In some embodiments, play area boundaries, number of rounds, time per round, player handicaps, other game data, or combinations thereof are received at the controller.

In some embodiments, a kit includes the controller, one or more additional controllers, and a computing device configured to communicate with the controller and the one or more additional controllers.

In some embodiments, a method for single-handedly remote controlling an aircraft comprising one or more of: upon rotating the controller of any of claims 1-61 about a longitudinal axis of the controller, sending a command to the aircraft to adjust roll of the aircraft; upon rotating the controller of any of claims 1-61 about an axis orthogonal to the longitudinal axis, sending a command to the aircraft to adjust pitch of the aircraft; or upon activating an input mechanism of the controller of any of claims 1-61, sending a command to the aircraft to adjust thrust and/or yaw of the aircraft.

In some embodiments, the method further includes upon activating an input mechanism, sending a command to adjust trim of the aircraft.

In some embodiments, the method further includes upon activating an input mechanism, sending a command to the aircraft to adjust and/or reset attitude sensors in the aircraft.

In some embodiments, the method further includes upon activating an input mechanism, sending a command to the aircraft to maintain one or more of a current heading, a position, an orientation, or combinations thereof of the aircraft.

In some embodiments, the method further includes indicating one or more of a current heading, a position, an orientation, or combinations thereof of the aircraft.

In some embodiments, the method further includes how quickly or slowly the aircraft is moving in one or more directions based on one or more of light intensity, colors, position of the light on the controller, or combinations thereof.

In some embodiments, the method further includes indicating user data and/or personality of types of commands commonly performed by the user.

In some embodiments, indicating more of one hue than another hue indicates that the user uses more passive commands than aggressive command.

In some embodiments, an intensity of the hue indicates a leveling up of the user's commands.

In some embodiments, the method further includes indicating remaining battery charge using one or more of different colors and/or flashing patterns.

In some embodiments, the method further includes charging a battery of the controller.

In some embodiments, charging the battery of the controller includes receiving a charge via a wire and/or receiving a wireless charge.

In some embodiments, the method further includes receiving a shut-down command.

In some embodiments, after receiving an immediate shutdown command, sending a command to the aircraft to shut down.

In some embodiments, after the controller sends a command to the aircraft to shut down, the controller waits for confirmation that the shutdown command was received.

In some embodiments, after receiving confirmation that the shutdown command was received, disabling one or more features of the controller.

In some embodiments, after receiving confirmation that the shutdown command was received, all features of the controller are disabled.

In some embodiments, the method further includes performing one or more actions with a single hand.

In some embodiments, the method further includes when tilting of the controller is detected, sending a command to the aircraft to flutter appendages of the aircraft.

In some embodiments, the method further includes upon activating an input mechanism of the controller of any of claims 1-61, sending a command to the aircraft to adjust appendage fluttering instructions.

In some embodiments, the method further includes upon activating an input mechanism of the controller of any of claims 1-61, sending a command to turn on or off a flapping effect of the aircraft.

In some embodiments, activating an input mechanism includes attitude and/or thrust instructions corresponding to one or more flutter controls.

In some embodiments, changing the thrust level changes a flapping frequency of the aircraft.

In some embodiments, flapping each appendage at a different rate than other appendages for sent roll and/or yaw commands.

In some embodiments, appendages tilt for received pitch commands.

In some embodiments, the method further includes sending an instruction to one or more of the aircraft, one or more of other controllers, or combinations thereof.

In some embodiments, the instruction is sent after detecting one or more input patterns.

In some embodiments, the at least one input includes one or more of a button, a microphone, a sensor, or combinations thereof.

In some embodiments, the one or more input patterns include one or more button combinations, one or more voice commands, one or more motion patterns, or combinations thereof.

In some embodiments, the method further includes sensing other users' aircraft and/or other users' controllers via one or more of RF, one or more of IR, one or more of acoustic, one or more of optical, one or more of other spectra, or combinations thereof.

In some embodiments, the method further includes when the controller is pointed at another users' aircraft or another users' controller and a command is sent from the controller, sending a command to a targeted aerial vehicle and/or a targeted controller.

In some embodiments, the method further includes altering and/or toggling on or off one or more features and/or one or more capabilities of the controller of any of claims 1-61 based on one or more of one or more parental controls, one or more user preferences, one or more game mode data, or combinations thereof.

In some embodiments, the method further includes deactivating a security system of the controller.

In some embodiments, the security system is configured to be temporarily overridden by other users' controllers via signals received by the controller of any of claims 1-61.

In some embodiments, the method further includes selecting one or more game modes including Training mode, Questing mode, Battle mode, other game modes, or combinations thereof.

In some embodiments, the one or more game modes are selected by a signal received from a computing device.

In some embodiments, a method of interacting with a plurality of the controllers of any of proceeding paragraphs includes receiving communication from the plurality of the controllers paired with one or more aerial vehicles.

In some embodiments, the method further includes sending player data, user preferences, program commands, parental control settings, game mode selection, game mode rule management, team configuration, other game data, or combinations thereof.

In some embodiments, the method further includes receiving player data, user preferences, program commands, parental control settings, game mode selection, game mode rule management, team configuration, other game data, or combinations thereof.

In some embodiments, the method further includes sending play area boundaries, number of rounds, time per round, player handicaps, other game data, or combinations thereof.

In some embodiments, the method further includes receiving play area boundaries, number of rounds, time per round, player handicaps, other game data, or combinations thereof.

In some embodiments, device, apparatus, system, kit, component, or subcomponent as illustrated or described, or method of manufacture or use thereof.

In some embodiments, a single-handed controller for controlling an aerial vehicle includes a body having an elongated shape; an input mechanism positionable in a plurality of positions; an orientation sensor configured to detect a rotation of the body about at least one axis; a transmitter configured to send commands to the aerial vehicle; a processor; a memory in electronic communication with the processor; and instructions stored in the memory which, when executed by the processor, cause the processor to: detect a rotation of the body about the at least one axis with the orientation sensor; send a command with the transmitter to change an angle of the aerial vehicle based on detecting the rotation of the body about the at least one axis; detect the input mechanism being positioned in a first position of the plurality of positions; and send a command with the transmitter to change one or more of a thrust or a yaw of the aerial vehicle based on the input mechanism being positioned in the first position.

In some embodiments, the orientation sensor is configured to detect a first rotation of the body about a first axis and a second rotation of the body about a second axis, and the transmitter is configured to send commands to change a pitch of the aerial vehicle based on detecting the first rotation and to change a roll of the aerial vehicle based on detecting the second rotation.

In some embodiments, the input mechanism is a joystick positionable in the plurality of positions in two axes, and the transmitter is configured to send commands to change the thrust of the aerial vehicle based on the first position with respect to a first axis of the two axes, and to change the yaw of the aerial vehicle based on the first position with respect to a second axis of the two axes.

In some embodiments, the controller further includes at least one button configured to send commands to adjust a trim the aerial vehicle.

In some embodiments, the controller further includes at least one button configured to send commands to reset an attitude sensor of the aerial vehicle.

In some embodiments, the controller further includes at least one button configured to send commands to maintain one or more of a current heading, a position, or an orientation of the aerial vehicle.

In some embodiments, the controller further includes a two-axis light configured to indicate a pitch levelness and a roll levelness of the aerial vehicle.

In some embodiments, the controller further includes a light indicator configured to indicate user data of a user, wherein the user data includes one or more of a user personality of the user related to types of commands the user typically performs, wherein the user personality.

In some embodiments, the light indicator indicates the user personality by a color, and wherein the user personality is related to the user performing more aggressive commands or more passive commands.

In some embodiments, the light indicator indicates a skill level of the user by a light intensity.

In some embodiments, the controller further includes a rechargeable battery positionable within the body for powering one or more of the input mechanism, the orientation sensor, the transmitter, the processor, or the memory, and a power receiving unit for charging the rechargeable battery, wherein the power receiving unit is configured for one or more of wired charging or wireless charging.

in some embodiments, the transmitter is configured to communicate via one or more of radio frequency (RF) signals, infrared (IR) signals, optical signals, or acoustic signals.

In some embodiments, the transmitter is directional to selectively transmit signals in a specific direction.

In some embodiments, the controller further includes a security device configured to disable the controller until the security device is deactivated.

In some embodiments, the controller further includes a body extension connected to and extending from the body, wherein the body is positionable in and proportional to grasp of a hand of a user, and wherein, when the controller is grasped by the user, the body extension extends past the grasp of the hand of the user.

In some embodiments, a method for single-handed remote controlling of an aerial vehicle includes detecting a rotation of a body of a controller in communication with the aerial vehicle; transmitting, from the controller and to the aerial vehicle, a command to change an angle of the aerial vehicle based on the rotation of the body; detecting a position of an input mechanism of the controller; and transmitting, from the controller and to the aerial vehicle, a command to change one or more of a thrust or a yaw of the aerial vehicle based on the position; wherein the rotation of the body and the position of the input mechanism are input to the controller by a single hand of a user of the controller.

In some embodiments, detecting the rotation includes detecting a first rotation of the body about a first axis, and detecting a second rotation of the body about a second axis

In some embodiments, transmitting the command to change the angle includes transmitting a pitch command to change a pitch of the aerial vehicle based on the first rotation, and transmitting a roll command to change a roll of the aerial vehicle based on the second rotation.

In some embodiments, the aerial vehicle includes at least one actuatable appendage that is actuatable to flutter, and the method further includes, in connection with transmitting the pitch command, transmitting a command to adjust an angle of the at least one actuatable appendage, and in connection with transmitting the roll command, transmitting a command to adjust one or more of a magnitude or a speed of fluttering of the at least one actuatable appendage.

In some embodiments, detecting the position includes detecting a first axial component of the position along a first axis, and detecting a second axial component of the position along a second axis.

In some embodiments, transmitting the command to change one or more of the thrust or yaw includes transmitting a thrust command to change the thrust of the aerial vehicle based on the first axial component of the position, and transmitting a yaw command to change the yaw of the aerial vehicle based on the second axial component of the position.

In some embodiments, the aerial vehicle includes actuatable appendages that are actuatable to flutter including a first actuatable appendage and a second actuatable appendage, and the method further includes, in connection with transmitting the thrust command, transmitting a first command to adjust one or more of a magnitude or a speed of fluttering of the actuatable appendages, and in connection with transmitting the yaw command, transmitting a second command to adjust the one or more of the magnitude or the speed of the fluttering of the actuatable appendages, wherein the one or more of the magnitude or the speed of the fluttering of the actuatable appendages is based on a combination of both the first command and the second command, and wherein the second command causes the first actuatable appendage and the second actuatable appendage to flutter at one or more of a different magnitude or a different speed.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A single-handed controller for controlling an aerial vehicle, comprising:
a body having an elongated shape;
a processor connected to the body;
a transmitter connected to the body and in electronic communication with the processor;
one or more of:
an input mechanism connected to the body and positionable in a plurality of positions, the input mechanism in electronic communication with the processor; or
an orientation sensor connected to the body and in electronic communication with the processor;
a memory in electronic communication with the processor having instructions stored in
the memory which, when executed by the processor, cause the processor to:
one or more of:
using the orientation sensor:
detect a rotation of the body about the at least one axis; or
using the input mechanism:
detect a first position of the plurality of positions;
using the transmitter one or more of:
send a command to change an angle of the aerial vehicle based on detecting the rotation of the body about the at least one axis; or
send a command to change one or more of a thrust or a yaw of the aerial vehicle based on the input mechanism being positioned in the first position.

2. The controller of claim 1, wherein the orientation sensor is configured to detect a first rotation of the body about a first axis and a second rotation of the body about a second axis, and the transmitter is configured to send commands to change a pitch of the aerial vehicle based on detecting the first rotation and to change a roll of the aerial vehicle based on detecting the second rotation.

3. The controller of claim 1, wherein the input mechanism is a joystick positionable in the plurality of positions in two axes, and the transmitter is configured to send commands to change the thrust of the aerial vehicle based on the first position with respect to a first axis of the two axes, and to change the yaw of the aerial vehicle based on the first position with respect to a second axis of the two axes.

4. The controller of claim 1, further comprising at least one button is configured to send commands to adjust a trim of the aerial vehicle.

5. The controller of claim 1, further comprising at least one button configured to send commands to reset an attitude sensor of the aerial vehicle.

6. The controller of claim 1, further comprising at least one button configured to send commands to maintain one or more of a current heading, a position, or an orientation of the aerial vehicle.

7. The controller of claim 1, further comprising a two-axis light configured to indicate a pitch levelness and a roll levelness of the aerial vehicle.

8. The controller of claim 1, further comprising a light indicator configured to indicate user data of a user, wherein the user data includes one or more of a user personality of the user related to types of commands the user typically performs, wherein the user personality.

9. The controller of claim 8, wherein the light indicator indicates the user personality by a color, and wherein the user personality is related to the user performing more aggressive commands or more passive commands.

10. The controller of claim 9, wherein the light indicator indicates a skill level of the user by a light intensity.

11. The controller of claim 1, further comprising a rechargeable battery positionable within the body for powering one or more of the input mechanism, the orientation sensor, the transmitter, the processor, or the memory, and a power receiving unit for charging the rechargeable battery, wherein the power receiving unit is configured for one or more of wired charging or wireless charging.

12. The controller of claim 1, wherein the transmitter is configured to communicate via one or more of radio frequency (RF) signals, infrared (IR) signals, optical signals, or acoustic signals.

13. The controller of claim 1, wherein the transmitter is directional to selectively transmit signals in a specific direction.

14. The controller of claim 1, further comprising a security device configured to disable the controller until the security device is deactivated.

15. The controller of claim 1, further including a body extension connected to and extending from the body, wherein the body is positionable in and proportional to grasp of a hand of a user, and wherein, when the controller is grasped by the user, the body extension extends past the grasp of the hand of the user.

16. A method for single-handed remote controlling of an aerial vehicle, comprising:
detecting a rotation of a body of a controller in communication with the aerial vehicle;
transmitting, from the controller and to the aerial vehicle, a command to change an angle of the aerial vehicle based on the rotation of the body;
detecting a position of an input mechanism of the controller; and
transmitting, from the controller and to the aerial vehicle, a command to change one or more of a thrust or a yaw of the aerial vehicle based on the position;
wherein the rotation of the body and the position of the input mechanism are input to the controller by a single hand of a user of the controller.

17. The method of claim 16, wherein:
detecting the rotation includes:
detecting a first rotation of the body about a first axis; and
detecting a second rotation of the body about a second axis; and
transmitting the command to change the angle includes:
transmitting a pitch command to change a pitch of the aerial vehicle based on the first rotation; and
transmitting a roll command to change a roll of the aerial vehicle based on the second rotation.

18. The method of claim 17, wherein the aerial vehicle includes at least one actuatable appendage that is actuatable to flutter, and further comprising:
in connection with transmitting the pitch command, transmitting a command to adjust an angle of the at least one actuatable appendage; and
in connection with transmitting the roll command, transmitting a command to adjust one or more of a magnitude or a speed of fluttering of the at least one actuatable appendage.

19. The method of claim 16, wherein:
detecting the position includes:
detecting a first axial component of the position along a first axis; and
detecting a second axial component of the position along a second axis; and
transmitting the command to change one or more of the thrust or yaw includes:
transmitting a thrust command to change the thrust of the aerial vehicle based on the first axial component of the position; and
transmitting a yaw command to change the yaw of the aerial vehicle based on the second axial component of the position.

20. The method of claim 19, wherein the aerial vehicle includes actuatable appendages that are actuatable to flutter including a first actuatable appendage and a second actuatable appendage, and further comprising:
in connection with transmitting the thrust command, transmitting a first command to adjust one or more of a magnitude or a speed of fluttering of the actuatable appendages; and
in connection with transmitting the yaw command, transmitting a second command to adjust the one or more of the magnitude or the speed of the fluttering of the actuatable appendages, wherein the one or more of the magnitude or the speed of the fluttering of the actuatable appendages is based on a combination of both the first command and the second command, and wherein the second command causes the first actuatable appendage and the second actuatable appendage to flutter at one or more of a different magnitude or a different speed.
